(19) United States
(12) Patent Application Publication
(10) Pub. No.: US 2011/0149605 A1
(43) Pub. Date: Jun. 23, 2011

(54) LIGHT GUIDE SHEET AND KEY SHEET USING THE SAME

(76) Inventor: Ryo Sato, Niigata (JP)

(21) Appl. No.: 13/060,144

(22) PCT Filed: Aug. 12, 2009
(86) PCT No.: PCT/JP2009/064223

§ 371 Date: Feb. 22, 2011

(30) Foreign Application Priority Data
Sep. 5, 2008 (JP) 2008-228583

(51) Int. Cl. F21V 8/00

(52) U.S. Cl. 362/619; 362/628

(57) ABSTRACT

There is provided a light guide sheet and a key sheet using said light guide sheet, said light guide provided at the rear surface side of a key top configured with a plurality of key buttons, said light guide sheet guiding light beam from a light source for lighting up said plurality of key buttons from their back surface side, comprising: a light guide portion having a plate-like shape; a periphery portion formed integrally around said light guide portion, said periphery portion whose thickness is thinner than that of said light guide portion, in which a surface facing the rear surface of said key top has a flat surface, and a side surface is a receiving surface of the light beam outputted by said light source, wherein said periphery portion maintains a distance between the rear surface of said key top and the front surface of said light guide portion in a certain distance when said flat surface of said periphery portion contacts the rear surface of said key top.

### TECHNICAL FIELD

The present invention relates to a light guide sheet and a key sheet using such light guide sheet for a portable electronic device, such as a cellular phone, a portable information terminal (PDA (Personal Data Assistance).

### BACKGROUND ART

A key sheet is widely used as a component for portable electronic device such as a cellular phone, a portable information terminal (PDA). Such key sheet is normally made of resin such as polycarbonate, and it is formed such that a key top in which a plurality of key buttons are formed and a key base made of elastic material such as silicon rubber or thermoplastic elastomer are connected together. A pressing element is formed at the position corresponding to each key button on the rear surface of the key base. When the key button is operated downward by a finger of a user or the like, the pressing element moves to press down a metal dome located on a print circuit board which is arranged to face the pressing elements. Therefore the metal dome touches an electrical contact and the switch is turned on. Whereas when the pressing force onto the key button is released, the metal dome moves apart from the electrical contact and the switch is turned off.

Regarding the above mentioned push button switch, an illuminated type push button switch whose key buttons are illuminated from their backside is widely used in order to make a portable electronic device operative even in the dark and to enhance design advantage for the pushing button switch. Normally a LED (Light Emitting Diode) is utilized as a light source. Mainly such illuminated type push button switch is categorized into the following types; the type where the key buttons are illuminated by providing a plurality of LEDs whose emitting surfaces are directed to key buttons on a printed circuit board, and the type where the key buttons are illuminated by providing a sheet-like light guide member (hereinafter called “a light guide sheet”) in which light beam of the LED received from the side surface is scattered at the location corresponding to each key button. In recent years, the type using the light guide sheet becomes popular because a number of the LEDs can be reduced, thereby reducing electric power consumption, and it is easily achieved to make a portable electronic device thinner according to market demands.

Various kinds of ideas for inputting more light beam into the light guide sheet are proposed so far. In the Patent document 1, for example, there is provided a light guide sheet in which a side surface at one edge of rectangular light guide sheet is enlarged in its thickness direction for working as a light receiving surface of LED light beam and a sectional shape slants gently from the light receiving surface to a sheet main body.

The Patent document 2 discloses a light guide sheet in which thickness of a plate-like light guide sheet having a rectangular planner shape reaches a top surface of a printed circuit board at one edge, and which has an approximately taper sectional shape whose thickness increases gradually from the back surface of the light guide sheet (a side surface of the printed circuit board) to the edge.
[Patent Document 1] Japanese Patent Publication No. 4080271
[Patent Document 2] Japanese Patent Application Laid-Open No. 2006-323843

The light guide sheet disclosed in the above mentioned Patent Document 1 will have a risk where an angle or a position of the light receiving surface relative to a LED's output surface will become out of alignment and amount of the LED light beam inputted into the light guide sheet will be reduced because the light guide sheet is incorporated into the portable electronic device on the condition that the light guide sheet is only mounted between a casing and the printed circuit board. There is also a risk where parts management or assembly process will become complex because it is impossible to incorporate the light guide sheet, the key top, printed circuit board or the like into one module.

Regarding the light guide sheet disclosed in the Patent Document 2, a pressing element is formed such as protruding towards a metal dome on the rear surface of the light guide sheet. This pressing element is made of an elastic material so as to give a user a good operative feeling with a click feeling together with rigidity of the metal dome. Therefore the light guide sheet disclosed in the Patent document 2 has a problem where it is difficult to form a reflection pattern to scatter light beam transmitted in the light guide sheet towards the key top in addition to the problem similar to that of the light guide sheet disclosed in the Patent document 1. In other words, when the reflection pattern is formed by printing or providing fine convexities, printing of the reflection pattern or manufacture of a metal mold to form the fine concavities is difficult because the pressing element (i.e., a projection) exists on the surface on which the reflection pattern is formed.

### DISCLOSURE OF THE INVENTION

The present invention addresses the above-identified problems, and an object of the present invention is to provide a light guide sheet and a key sheet using this light guide sheet into which more light beam from a light source can be inputted through a side surface, whose assembly position can be secured in a portable electronic device into which the light guide sheet is incorporated, in which it is easier to form a reflection pattern to light up a key button as well as to modularize together with other components.

In order to achieve the object, according to the present invention, there is provided a light guide sheet arranged at the rear surface side of a key top configured with a plurality of key buttons, said light guide sheet guiding light beam from a light source for lighting up said plurality of key buttons from their back surface side, comprising: a light guide portion having a plate-like shape; a periphery portion formed integrally around said light guide portion, said periphery portion whose thickness is thinner than that of said light guide portion, in which a surface facing the rear surface of said key top has a flat surface, and a side surface is a receiving surface of the light beam outputted by said light source, wherein said periphery portion maintains a distance between the rear surface of said key top and the front surface of said light guide portion in a certain distance when said flat surface of said periphery portion contacts the rear surface of said key top.

According to the light guide sheet regarding the present invention, the side surface of the periphery portion whose thickness is thinner than that of the light guide portion acts as a receiving surface of the light beam outputted by the light source. Therefore more light beam can be imported in comparison with the case where a normal side surface of the light guide portion is simply used as a receiving surface. Regarding the periphery portion, since a surface which faces the rear surface of the key top has a flat surface, this flat surface can be fixed stably using a adhesive tape or the like, and additionally it can reduce a risk where amount of the inputted light beam is reduced by misalignment of the light guide sheet or the like in the portable electronic device. Further, it can modularize the components of the key top side and the light guide sheet easily. Even if the flat surface of the periphery portion is connected to the rear surface of the key top, e.g., in the case that the pressing element is formed on the rear surface of key top, it can avoid surplus tensile force caused by the pressing element pressed onto the front surface of the light guide portion, thereby reducing a risk for damaging the light guide sheet because a distance between the rear surface of the key top and the front surface of the light guide surface is maintained in a certain distance.

On the above mentioned light guide sheet according to the present invention, a plurality of convex portions corresponding to said plurality of key buttons are integrally formed on the front surface of said light guide portion, scattering portions for scattering the light beam transmitting in said light guide portion are provided at the position corresponding to said plurality of key buttons on the rear surface of said light guide portion, said periphery portion maintains a distance between the rear surface of said key top and the front surface of said light guide portion in a certain distance so that tops of said convex portions contacts the rear surface of said key top when said flat surface of said periphery portion contacts the rear surface of said key top.

According to the light guide sheet regarding the present invention, the convex portions protruding towards each of the key buttons are integrally formed at the position corresponding to each key button on the front surface of the light guide, i.e., a surface facing the rear surface of the key top. Therefore these convex portions can act as ordinary pressing elements, they can bring a good click feeling, and they can transmit the pressing force to the metal domes on the circuit board certainly. Since the convex portions are formed on the front surface of the light guide portion, the rear surface of the light guide portion can have a flat surface, and a scattering portion which scatters light beam transmitted in the light guide portion can be formed on this flat surface. Therefore it is easier to print reflection patterns acting as the scattering portion, or to manufacture a metal mold for forming the fine concavities acting as the scattering portion on the rear surface of the light guide portion, in comparison with the case that the pressing element is formed on the rear surface of the light guide portion.

On any of the above mentioned light guide sheets according to the present invention, said periphery portion is formed all around said light guide portion.

According to the present invention, since the periphery portion is formed all around the light guide portion, the periphery portion has a function of a rib thereby enhancing strength of the light guide sheet, and also enhancing freedom for setting position of the light source in the casing of the portable electronic device because area of the receiving surface increases.

On any of the above mentioned light guide sheets according to the present invention, a surface of said periphery portion facing a circuit board, provided on the rear surface of said light guide portion has a flat surface, a difference of height in thickness direction between said flat surface and the rear surface of said light guide portion is approximately equal to a height of metal domes formed on said circuit board, said metal domes containing electrical contacts which turn on or turn off according to a pressing force imposed by said key buttons.

Regarding the light guide sheet according to the present invention, since the surface of the periphery portion facing the circuit board also has a flat surface, it is possible to stably fix the light guide sheet to the rear surface of the key top, the surface of the circuit board or both surfaces, according to its necessity. Since difference of height in thickness direction between the flat surface facing the circuit board and the rear surface of the light guide portion is approximately equal to a height of metal domes formed on the circuit board, for example, in the case the light guide sheet is fixed to circuit board side, it can avoid surplus tensile force by the light guide sheet pressed onto the metal dome, thereby reducing a risk of damaging the light guide sheet.

On any of the above mentioned light guide sheets according to the present invention, a thickness from said periphery portion to said light guide portion changes continuously.

According to the light guide sheet regarding the present invention, since thickness from the periphery portion to the light guide portion changes continuously, there is no step between the periphery portion and the light guide portion. Therefore it can reduce a risk where the light beam inputted from the side surface, for example, reflects towards the opposite direction to the traveling direction, thereby reducing loss of the light beam inputted into the light guide portion.

On any of the above mentioned light guide sheets according to the present invention, a reflection layer is formed on the rear surface of said light guide portion and said periphery portion.

According to the light guide sheet regarding the present invention, since light beam which might be projected out of the light guide sheet can return into the light guide sheet, it can reduce loss of the light beam for lighting up the key buttons.

According to the present invention, a key sheet used for a pressing switch for a portable electronic device, said key sheet transmitting a pressing force to be imposed externally to a metal dome formed on a circuit board in said portable electronic device, said metal dome containing an electrical contact which turns on or turns off according to said pressing force, comprising; any one of the above mentioned light guide sheet, an intermediate layer including a urethane made layer fixed on the front surface of said light guide sheet, a key top configured with a plurality of key buttons fixed on a front surface of said intermediate layer.

According to the key sheet regarding the present invention, since each component such as a plurality of key buttons operated by a user and the light guide sheet having the above mentioned various kind of features for lighting up the plurality of key buttons can be modularized, it can simplify management of the parts which configure the portable electronic device or assembly process of the portable electronic device.

### EFFECT OF THE INVENTION

According to the light guide sheet and the key sheet using such light guide sheet regarding the present invention, more light beam from a light source can be inputted through a side surface of the light guide sheet, assembly position thereof can be secured in a portable electronic device into which they are incorporated, and it is made easier to form a reflection pattern to light up a key button as well as to modularize together with other components.

### BRIEF DESCRIPTION OF THE DRAWINGS

FIG. 1 is a front view for illustrating an outline of the key sheet using one embodiment of the light guide sheet according to the present invention;

FIG. 2 is an exploded perspective view for illustrating configuration of the key sheet;

FIG. 3 is (a) a front view and (b) a back view of one embodiment of the light guide sheet according to the present invention;

FIG. 4 is a cross-sectional view for illustrating a vertical section adjacent to a periphery part of the light guide sheet;

FIG. 5 is a cross-sectional view for illustrating a part of the section of the key sheet using one embodiment of the light guide sheet on the condition it is incorporated in a casing of the portable electronic device.

### DETAILED DESCRIPTION OF THE INVENTION

Embodiments of a light guide sheet according to the present invention and a key sheet using such light guide sheet will be described in detail below referring to the accompanying drawings.

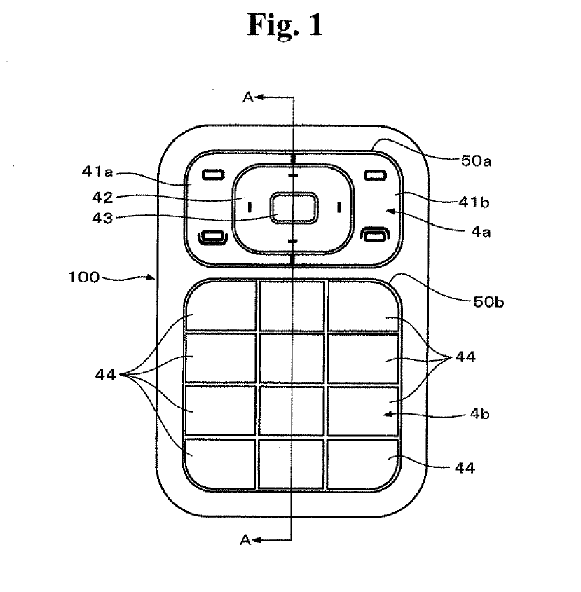

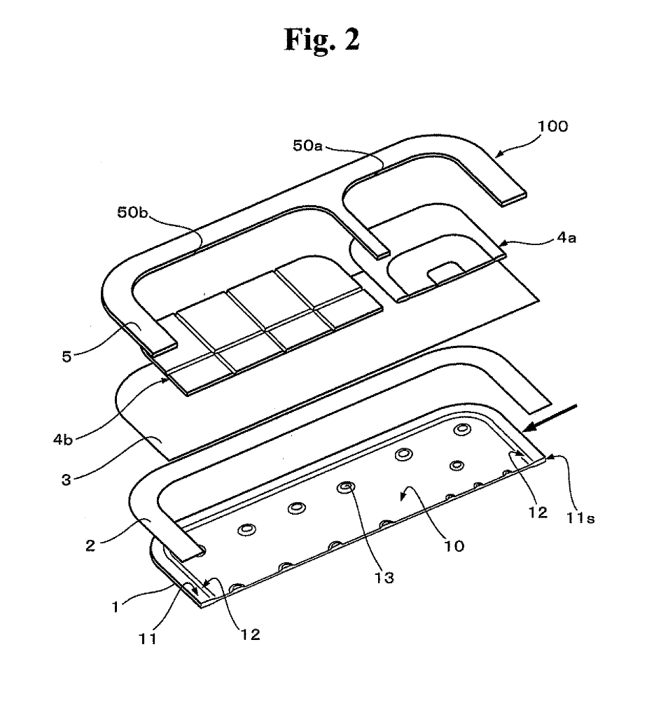

FIG. 1 is a front view for illustrating an outline of the key sheet using one embodiment of the light guide sheet according to the present invention. FIG. 2 is an exploded perspective view seeing the key sheet described in FIG. 1 from upper direction, showing A-A section along the center line in longitudinal direction of the key sheet in FIG. 1.

As shown in FIG. 1 and FIG. 2, on a key sheet 100 according to the present invention, a top cover 5 made of resin having a rectangular planner shape formed with four round corners, and key tops 4a and 4b contained within the inside of openings 50a and 50b respectively which are opened in the top cover 5 are arranged at the top surface thereof. The Key top 4a is configured with a plurality of the key tops made of resin such as functional keys 41a,41b, a cursor key 42 and an enter key 43, and the key top 4b is configured with 12 pieces of key buttons 44 made of resin (reference numerals are made only a part of them in FIG. 1). Although illustration is omitted in FIGS. 1 and 2, characters, marks, numbers or the like are allocated respectively on a surface of each key top 44 by printing or the like. Each key button which configures the key top 4a and 4b is, for example, arranged with a space of 0.2 mm or less between adjacent key tops, in other words, arranged so called at narrow pitch.

As shown in FIG. 2, the above mentioned key top 5 and key tops 4a, 4b are adhered to an adhesive layer (not shown) formed on a surface of a sheet 3 made of urethane(urethane made sheet). The urethane made Sheet 3 is adhered to the light guide sheet 1 with an adhesive tape 2 whose periphery matches the periphery of the urethane made sheet 3, and has a certain width. Since the urethane made sheet 3 is relatively soft and has elasticity, it can increase adhesiveness to the key tops 4a, 4b which are located at the upper surface thereof, and it can make operative feeling of a user more comfortable. However, a material for the sheet to which the top cover 5 and key top 4a, 4b are adhered is not limited to urethane, and a sheet made of polycarbonate (PC), polyethylene terephthalate (PET) or the like is also usable if such material has flexibility to deform with the above mentioned pressing force added to the key top 4a, 4b and have strength to bear such pressing force.

According to the above mentioned configuration, configuration from the top cover 5 and the key top 4a, 4b to the light guide sheet 1 can be treated as one module (i.e., key sheet 100). The above mentioned adhesive layer, the urethane made Sheet 3 and the adhesive tape 2 correspond to an intermediate layer including the urethane layer, and at least the adhesive layer and the urethane made sheet 3 have translucency.

The above mentioned key sheet 100 has the top cover 5, and top cover 5 can secure general shape stability and rigidity of the key sheet 100, and can fix position of the key top. The present invention is not limited to the key sheet with the top cover, but is also applicable to, for example, a narrow pitch key sheet including a key pad member having elasticity such as urethane rubber, silicon rubber, thermoplastic elastomer or the like and a sheet-like reinforce member (i.e., a reinforce plate) combined with the key pad member integrally or separately, or a key sheet of the type where a key top is fixed directly to a key pad member and position of each key top is fixed using a frame (an opening through which each key top is protrudes) made on a case of a portable electronic device.

As a resin material used for the top cover 5 and the key top 4a, 4b, for example, any kind of resin such as polycarbonate resin(PC), polyethylene terephthalate resin(PET), polybutylene terephthalate resin (PBT), nylon, polypropylene (PP), fluorocarbon resin(PFA/FEP) and polyolefin fiber, and mixture thereof can be used. A material for the top cover 5 and key top 4a is not limited to resin, but any other material can also be used as far as it can flexibility, elasticity and strength against the pressing force by a user. For example, the top cover 5 and key top 4a, 4b can be configured with a metal thin plate, in this case, any metal or alloy such as aluminum, stainless steel, alloy steel, titanium, copper, silver and gold can be used. A steel plate plated with zinc or the like can be also utilized. Further, one whose metal surface is coated with a ceramic material such as titian nitride or the like can be also utilized. Especially when a metal material is used for key tops 4a, 4b, it is preferable to form a notch portion corresponding to pre-allocated characters, marks, numbers or the like by etching process or the like. Accordingly, light beam from a light source passes through the notch portions to highlight the characters or the like allocated respectively.

It is possible to utilize, for example, thin plate-like resin, silicon rubber, thermoplastic elastomer or the like instead of the urethane made Sheet 3. As a material for the thin plate-like resin, any kind of resin such as polycarbonate (PC), polyethylene terephthalate (PET), polypropylene (PP), fluorocarbon resin(PFA/FEP) and polyolefin fiber can be used. The thermoplastic elastomer includes polystyrene elastomer, polyolefin elastomer, polyester elastomer, polyurethane elastomer, polyamide elastomer or the like.

As an adhesive layer (not shown in the drawings) which makes the key top 5 and key tops 4a, 4b adhere to the urethane made sheet 3, either of an adhesive agent or an adhesive sheet can be utilized as far as it has translucency. When the adhesive agent is used, for example, a heating type adhesive agent such as a hot melt adhesive agent can be used, and other adhesive agents to be suitable for adhesion of resin and urethane can be also used. In this case, for example, various kinds of adhesive agents such as chloroprene rubber adhesive, NBR adhesive, natural rubber adhesive, urethane adhesive, cyanoacrylate adhesive, polyester adhesive, polyolefin adhesive, UV adhesive and instant adhesive can be used. If the top cover 5 and key tops 4a, 4b are made of metal and a resin sheet is used instead of the urethane made sheet 3, for example, it can be considered to use an adhesive agent to be suitable for adhesion of metal and resin such as epoxy adhesive, polyester adhesive, cyanoacrylate adhesive or the like.

Further, for adhesion of the urethane made sheet 3 (the sheet to which the top cover 5 and the key 4a, 4b are adhered) and light guide sheet 1, not only the adhesive tape 2 but also any adhesive agent to be suitable for respective materials can be utilized.

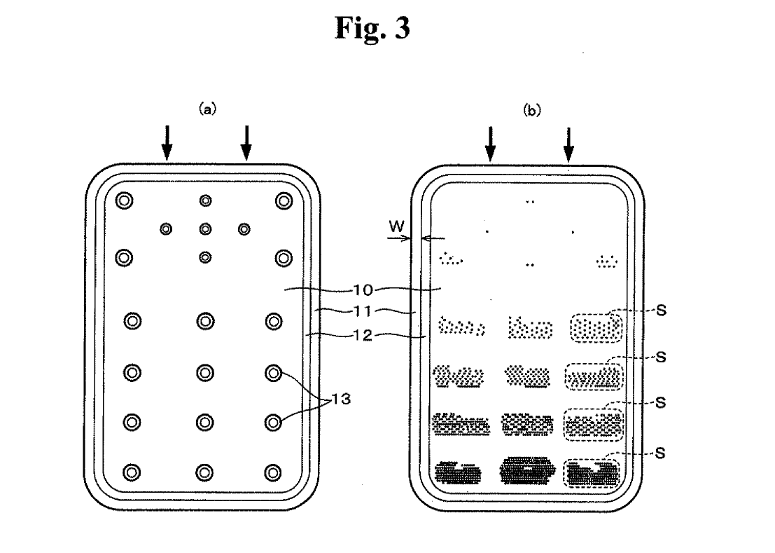

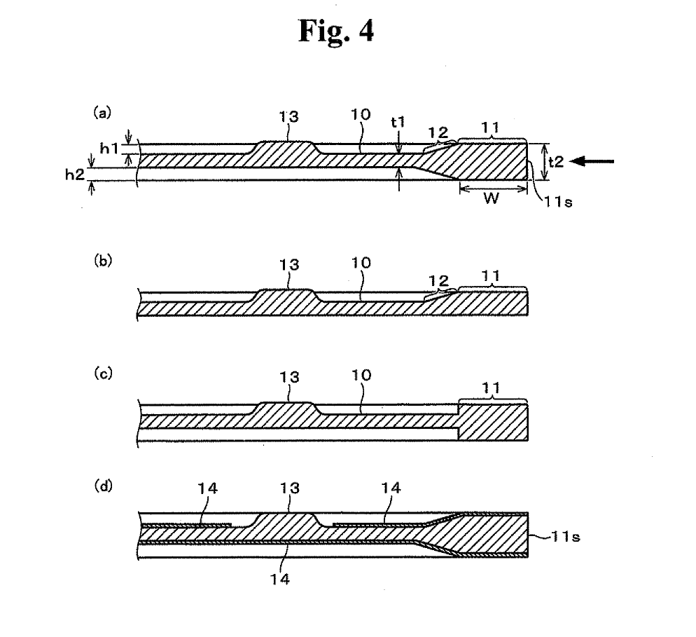

Next, configuration of the light guide sheet 1 will be explained referring to the above mentioned FIG. 2, FIG. 3 and FIG. 4. FIG. 3 is a front and back views for illustrating outline of the light guide sheet 1, specifically (a) shows a front view of the light guide sheet 1 and (b) shows a rear view of the light guide sheet 1. The front surface of the light guide sheet 1 is a surface facing the rear surface of the key tops 4a, 4b, and it is also called a top surface. The rear surface of the light guide sheet 1 is a surface facing a circuit board as mentioned later, and it is also called a bottom surface. FIG. 4 is a cross-sectional view for illustrating a vertical section adjacent to a periphery part of the light guide sheet 1, specifically (a) shows a section of the light guide sheet 1 as shown in FIGS. 2 and 3, (b) to (d) show other examples of cross-sectional shape adjacent to the periphery part of the light guide sheet respectively.

The light guide sheet 1 is made of translucent silicon rubber and is configured with a light guide portion 10 which has a plate-like shape with four round corners, and a periphery portion 11 formed integrally around the light guide portion 10. As a material for the light guide sheet 1, UV curing resin or thermoplastic elastomer or the like can be used as far as it has translucency and strength to bear pressing operation performed by a user. The above mentioned thermoplastic elastomer includes polystyrene elastomer, polyolefin elastomer, polyester elastomer, polyurethane elastomer, polyimide elastomer or the like. Thickness t2 of the periphery portion 11 is thinner than thickness t1 of the light guide portion 10 (refer to FIG. 4 (a)), and a taper portion 12 is formed from the periphery portion 11 to the light guide portion 10. Accordingly thickness changes continuously from the periphery portion 11 to the light guide portion 10. A front and rear surface of the periphery portion 11 have flat surfaces positioned parallel to the front and rear surfaces of the light guide portion 10 respectively, and is formed around the light guide portion 10 with a certain width w. Especially the surface of the periphery portion 11 becomes a contact surface with the above mentioned adhesive tape 2. A side surface 11s of the periphery portion 11 becomes a receiving surface of light beam outputted by a LED as mentioned below. For the light guide sheet 1 as shown in FIGS. 3 and 4, light beam is inputted at the positions (2 positions) as indicated by arrows in the drawings.

As shown in FIG. 3(a), the pressing element 13 (only a part of the pressing elements are marked with numerals in FIG. 3(a)) which protrudes towards the key top 4a, 4b is integrally formed at the position corresponding to each key which constitutes the key top 4a, 4b on the front surface of the light guide portion 10. In this embodiment, the pressing element 13 has a shape such that a top portion of a circular cone has a flat surface whose sectional shape is approximately trapezoidal shape, however, other shapes such as hemisphere or circular cylinder can be applicable. The height from the front surface of the light guide portion 10 to the top of the pressing element 13 is slightly exceeds the height difference h1 in thickness direction between the front surface of the light guide portion and the front surface of the periphery portion 11. Accordingly when the front surface of the periphery portion 11 contacts the rear surface of the key top 4a, 4b (specifically the adhesive tape 2), the front surface of the pressing element 13 contacts the rear surface of the key top 4a, 4b (specifically the urethane made Sheet 3). That is, the periphery portion 11 keeps the distance between the rear surface of the key tops 4a, 4b and the front surface of the light guide portion 10 such that the top of the pressing element 13 contacts the rear surface of the key tops 4a, 4b when the front surface of the periphery portion 11 contacts the rear surface of the key tops 4a, 4b.

In the case that the height of pressing element 13 is h1 as mentioned above (in the case that the height of the top of the pressing element 13 is equal to the height of the surface of the periphery portion 11), when the front surface of the periphery portion 11 contacts the adhesive tape 2, there might be a clearance between the top of the pressing element 13 and the urethane made Sheet 3 by the thickness of the adhesive tape 2. However a good click feeling at operating the key buttons will not be spoiled because in general thickness of the adhesive tape 2 is extremely thin (approx. 50 micrometer). Therefore the height from the front surface of the light guide 10 to the top of the pressing element 13 can be equal to the height of the height difference h1 in thickness direction between the front surface of the light guide surface and the front surface of the periphery portion 11.

Whereas, the rear surface of the light guide portion 10 has a flat surface and on the rear surface it has a scattering portion S formed at the position corresponding to each key button which constitutes the key tops 4a, 4b to scatter the light beam inputted from the side surface of the periphery portion 11. Although the scattering portion S (the area surrounded by the dot line, only a part of the scattering portion is marked) is formed by printing many dot patterns corresponding to the position of the key button in FIG. 3 (b), it may form the scattering portion S by forming a lot of fine concavities on the rear surface of the light guide sheet instead. In either way, it is easy to form the scattering portion S because the rear surface of the light guide sheet 10 has a flat surface. The light beam transmitted in the light guide sheet 10 is scattered by the scattering portion S, and such scattered light beam is projected from the top of the pressing element 13 to key button side, thereby lighting up the key button.

The height difference h2 in thickness direction between the rear surface of the light guide portion 10 and the rear surface of the periphery portion 11 is equal to the height from the front surface of the circuit board to the top of the metal dome as mentioned below. Accordingly when a modularized key sheet 100 is assembled into portable electronic device 100, it can avoid the case where the light guide portion 10 is pressed onto the metal dome thereby adding surplus tensile force because the rear surface of the light guide portion 10 is kept at higher position by the height of the metal dome.

A sectional shape from the periphery portion to the light guide portion 10 11 in the light guide sheet 1 can be those as shown in FIG. 4 (b) to (d) as well as FIG. 4 (a). Specifically FIG. 4 (b) shows the embodiment having an allover flat surface without making any difference of the height in the direction of thickness between the light guide portion 10 and the periphery portion 11 at the rear surface side of the light guide sheet 1. FIG. 4 (c) shows the embodiment whose thickness changes discontinuously without having the taper portion 12 as shown in FIG. 4 (a). FIG. 4 (d) shows the embodiment forming a reflection layer 14 on the front and rear surface of the light guide sheet 1 except the area opposed to the area in which the scattering portion S is formed on the surface of the light guide portion 10. Accordingly it can prevent the light beam inputted from the side surface 11s of the periphery portion 11 from leaking out of the light guide sheet 1 by reflecting the light beam towards inside of the light guide sheet 1, thereby reducing loss of light beam as much as possible. The reflection layer 14 may be formed at the side surface of the periphery portion 11 except the area to which light beam is inputted by the light source, or it may be formed only on the rear side of the light guide sheet 1.

The sectional shapes as shown in FIGS. 4 (a) to (d) can be combined. For example, the reflection layer 14 as shown in FIG. 4(d) may be formed at the rear surface side of the light guide sheet 1 in the sectional shape as shown in FIG. 4 (b). Further thickness may be changed discontinuously from the thickness of the periphery portion 11 to the thickness of the light guide portion 10.

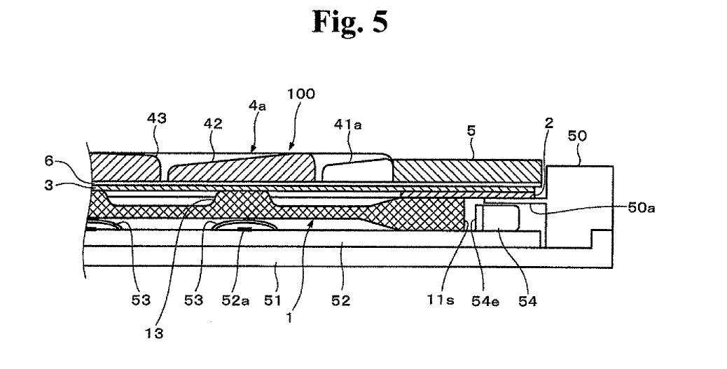

Next, it is described that the key sheet 100 as shown in FIGS. 1 and 2 is incorporated into the portable electronic device referring to FIG. 5. FIG. 5 illustrates a portion around the key top 4a at the section A-A of FIG. 1 on the condition that the key sheet 100 is incorporated into the portable electronic device. In this drawing, the same reference numeral as that of FIGS. 1 to 4 is specified for a part having the same configuration, and detailed explanation of such part will be omitted. Although it is omitted to mark each part of the light guide sheet 1 with reference numeral in order to avoid complexity in the drawing, the same light guide sheet as that shown in FIGS. 2, 3 and 4(a) is deemed to be utilized. In FIG. 5, there is shown the adhesive layer 6 formed on the front surface of the urethane made sheet 3 which is omitted to show in FIG. 2. It is also shown that an inner circumferential edge of the annular adhesive sheet 2 with a certain width matches with the border line between the surface of the periphery portion 11 and the taper portion 12 of the light guide sheet 1.

In FIG. 5, an opening which has the same shape as that of the top cover 5 is provided at the front surface side of the case 50 of the portable electronic device, and a stage 50a which contacts the adhesive sheet 2 which constitutes the key sheet 100 is formed on the inner surface of the casing 50. A back cover 51 is detachably attached to the rear surface of the casing 50. The circuit board 52 is connected to the surface of the back cover 51. On the circuit board, the metal dome 53 is fixed at the location corresponding to each key button and the LED 54 outputting light beam to the side surface 11s of the periphery portion 11 which constitutes the light guide sheet 1 is fixed. The metal dome 53 is a metal member having a dome-like shape, and for its material, any metal can be utilized as far as it has a certain amount of strength, elasticity, electrical conductivity and workability. There is an electrical contact 52a formed on the circuit board 52 inside the metal dome 53. When external pressing force is added to the metal dome 53, the metal dome 53 elastically deforms to contact the electrical contact 52a. Accordingly both parts are electrically connected and switch on stage can be detected. The LED 54 is provided on the circuit board 54 such that its emitting surface 54e faces the side surface of the periphery portion 11.

When the key sheet 100 is assembled into the above mentioned casing 50, the surface of outer circumferential edge of the adhesive sheet 2 to which the light guide sheet 1 is adhered is adhered to the surface of the stage 50a of the casing 50. It is preferable to form the stage 50a at the position where the rear surface of the periphery portion 11 contacts the surface of circuit board 52.

In such portable electronic device, for example, when the key button 42 is pressed down, the adhesive layer 6 and the urethane made Sheet 3 are deformed downward by the pressing force, thereby transferring the pressing force imposed on the key button 42 to the metal dome 53 corresponding to the key button 42. Accordingly the metal dome 53 elastically deforms to contact the electrical contact 52a thereby making switch on state, and operation of the key button 42 becomes detectable.

Although the pressing element is formed on the front surface of the light guide portion 10, in the light guide sheet 1 as shown in FIG. 3, it is possible to make the front surface of the light guide portion 10 flat as well as the rear surface if the pressing element is provided at the key top side. Even in this case, it is avoidable that the pressing element is pressed onto the surface of the light guide portion 10 thereby adding surplus tensile force when the light guide sheet 1 is fixed to the rear side of the key top by setting the height difference h1 (refer to FIG. 4(a)) in the thickness direction between the front surface of the light guide portion 10 and the front surface of the periphery portion 11 adequately.

Regarding the light guide sheet, although the above mentioned light guide sheet 1 is treated as a part of the key sheet 100, for example, the light guide sheet may be fixed to the front surface of the circuit board 52 by adhering an annular adhesive sheet like the adhesive sheet 2 to the rear side of the periphery portion 11.

The width w of the front and rear surface of the periphery portion 11 (refer to FIG. 4(a)) can have both the same dimension and the different dimension. Taper angle of the taper portion 12 can take any angle as far as it is less than 90 degrees, and can take different angle between the front and rear surface of the light guide sheet 1. The taper surface of the taper portion 12 can have both a convex curved surface and concave curved surface. The periphery portion 11 is formed all around the light guide portion 10, therefore it can contribute improvement of strength of the light guide sheet 1 because the periphery portion 11 acts as a rib portion. However if the distance between the rear surface of the key top and the front surface of the light guide portion 10 can be maintained with a certain distance (e.g., height dimension of the pressing element), it may have a portion in which the periphery portion 11 is not formed in a part of the periphery area of the light guide portion 10.

### DESCRIPTION OF REFERENCE NUMERALS

1: Light Guide Sheet
2: Adhesive sheet
3: Urethane Made Sheet
4a, 4b: Key Top
5: Top Cover
6: Adhesive layer
10: Light Guide Portion
11: Periphery Portion
11s: Receiving Surface
12: Taper Portion
13: Pressing Element
14: Reflection Layer
52: Circuit Board
53: Metal Dome
54: LED(Light Source)
54e: Emitting Surface
100: Key Sheet

1. A light guide sheet provided at the rear surface side of a key top configured with a plurality of key buttons, said light guide sheet guiding light beam from a light source for lighting up said plurality of key buttons from their back surface side, comprising:
a light guide portion having a plate-like shape;
a periphery portion formed integrally around said light guide portion, said periphery portion whose thickness is thinner than that of said light guide portion, in which a surface facing the rear surface of said key top has a flat surface, and a side surface is a receiving surface of the light beam outputted by said light source,
wherein said periphery portion maintains a distance between the rear surface of said key top and the front surface of said light guide portion in a certain distance when said flat surface of said periphery portion contacts the rear surface of said key top.

2. The light guide sheet according to claim 1,
wherein a plurality of convex portions corresponding to said plurality of key buttons are integrally formed on the front surface of said light guide portion,
scattering portions for scattering the light beam transmitted in said light guide portion are provided at the position corresponding to said plurality of key buttons on the rear surface of said light guide portion,
said periphery portion maintains a distance between the rear surface of said key top and the front surface of said light guide portion in a certain distance so that tops of said convex portions contact the rear surface of said key top when said flat surface of the periphery portion contacts the rear surface of said key top.

3. The light guide sheet according to claim 1, wherein said periphery portion is formed all around said light guide portion.

4. The light guide sheet according to claim 1,
wherein a surface of said periphery portion facing a circuit board, provided on the rear surface of said light guide portion has a flat surface, a difference of height in thickness direction between said flat surface and the rear surface of said light guide portion is approximately equal to a height of metal domes formed on said circuit board, said metal domes containing electrical contacts which turn on or turn off according to a pressing force imposed by said key buttons.

5. The light guide sheet according to claim 1,
wherein thickness from said periphery portion to said light guide portion changes continuously.

6. The light guide sheet according to claim 1,
wherein a reflection layer is formed on the rear surface of said light guide portion and said periphery portion.

7. A key sheet used for a pressing switch for a portable electronic device, said key sheet transmitting a pressing force to be imposed externally to a metal dome formed on a circuit board in said portable electronic device, said metal dome containing an electrical contact which turns on or turns off according to said pressing force, comprising;
the light guide sheet according to claim 1,
an intermediate layer including a urethane made layer fixed on the front surface of said light guide sheet,
a key top configured with a plurality of key buttons fixed on a front surface of said intermediate layer.
